(19) United States
(12) Patent Application Publication
(10) Pub. No.: US 2025/0348684 A1
(43) Pub. Date: Nov. 13, 2025

(54) SYSTEMS FOR AND METHODS FOR AGGREGATION AND VISUALIZATION OF LARGE-LANGUAGE-MODEL ANALYTICS DATA

(71) Applicant: AskHumans, Inc., Washington, DC (US)

(72) Inventor: Zachary KIDD, Washington, DC (US)

(73) Assignee: AskHumans, Inc., Washington, DC (US)

(21) Appl. No.: 19/201,704

(22) Filed: May 7, 2025

Related U.S. Application Data
(60) Provisional application No. 63/644,397, filed on May 8, 2024.
(60) Provisional application No. 63/667,204, filed on Jul. 3, 2024.

(51) Int. Cl. G06F 40/35; G06F 9/451

(52) U.S. Cl. CPC G06F 40/35; G06F 9/451

(57) ABSTRACT

Systems and methods for information aggregation and visualization are provided. A method includes presenting a plurality of instances of a user interface to a corresponding plurality of users, each instance including a user prompt. The method includes receiving, via each of the instances of the user interface, a user response to the user prompt. The method includes generating, responsive to the receipt of the responses, an instruction for ingestion into a large language model configured to construct an output text corpus. The method includes presenting, via the user interface, the output text corpus.

### CROSS-REFERENCE TO RELATED APPLICATIONS

This application claims priority to U.S. Provisional Patent Application No. 63/644,397, filed May 8, 2024, and U.S. Provisional Patent Application No. 63/667,204, filed Jul. 3, 2024, both of which are incorporated by reference in their entirety.

### TECHNICAL FIELD

This disclosure generally relates to the aggregation and visualization of analytic data. For example, the visualization can include generating a text corpus based on multiple reference sources.

### BACKGROUND

Aggregating distributed information can provide useful information but can prove challenging. For example, reviewers can experience different and related facets of a user experience (e.g., a restaurant or film). However, eliciting such information can introduce friction which may skew results. For example, survey respondents for a detailed survey may not be representative of a general population, and existing low-friction surveys may capture relatively sparse data. Further, reviewers can use different phraseology, exhibit different preferences, or have differing competencies for a subject matter of a review.

Even where reviewers are providing responses for a well-defined subject matter, such as providing document review or editing, aggregating responses can include iterative cycles which may lead to reviewer fatigue. Various reviewers can provide information that is conflicting or add new content. The new content may, in turn, remain subject to further review, leading to additional review cycles or bypassing review altogether. However, the information to resolve conflicts between reviewers, or provide the incremental review may be available and unused (e.g., latent information embedded in a first instance of reviews). Improvements in the art are desired.

### SUMMARY

An aggregator can ingest inputs from multiple users. For example, the aggregator can ingest reviews retrieved from private or publicly facing data feeds or receive inputs from various instances of a user interface. In some instances, the inputs may be received as free form text or speech. The inputs can concern a same source, such as a user experience, text corpus of a same document, or other aspect of a data source associated with each of the various users. The user interface can generate an instruction based on user inputs such as an indication of a weighting of one or more of the users, or an instruction to identify a sentiment or action related to the source. The aggregator can cause the various inputs and the instruction to be ingested by a machine learning model trained to generate textual outputs to generate a textual output indicative of the source. For example, the textual outputs can include a summary of multiple inputs, an updated text corpus incorporating the various inputs according to the instruction, or an action associated with the sentiment.

In one embodiment, a computer-implemented method may comprise presenting a plurality of instances of a user interface to a corresponding plurality of users, each instance comprising a user prompt; receiving, via each of the plurality of instances of the user interface, a user response to the user prompt; generating, responsive to the receipt of the user responses, an instruction for ingestion into a large language model configured to construct an output text corpus; and presenting, via the user interface, the output text corpus.

The user prompt may comprise a voice or textual free form entry.

The plurality of instances of the user interface may be configured to present an input text corpus, the user responses indicative of changes to the input text corpus; and the instructions may comprise instructions to modify the input text corpus based on the user responses, to generate the output text corpus.

The method may further comprise presenting, based on the user responses, a second user prompt providing an indication of the responses; receiving, responsive to the second user prompt, a user selection input, wherein the instruction is generated based on the user selection input, the user selection input comprising: an input weighting for at least one of the user responses.

The input weighting may comprise a first weight for a first portion of the text corpus and a second portion for a second portion of the text corpus.

The computer-implemented method of claim 5, wherein the input weighting comprises a zero-weight for at least one user responses.

Each of the user responses may comprise a description of a user experience; and the output text corpus may comprise a summary of the user experiences.

The method may comprise identifying, based on the user responses, a sentiment associated with the user experiences; predicting an action configured to modulate the sentiment; and presenting, via the user interface, the action.

The presentation of the action may comprise a presentation of a predicted magnitude of a change to the sentiment.

The method may further comprise presenting, via the user interface, a plurality of icons corresponding to the plurality of user responses, the plurality of icons indicating a sentiment of a corresponding user responses.

In another embodiment, a system for revision consolidation may comprise one or more processors coupled with memory and configured to: present, via a plurality of first instances of a user interface associated with a corresponding plurality of users, an input text corpus and a user prompt to indicate a request for revisions to the input text corpus; receive, via each of the plurality of first instances of the user interface, a user response to the user prompt, the user response comprising indicia of the revisions; present, via a second instance of the user interface, an indication of the user responses; receive, from the second instance of the user interface, input weightings for the user responses; generate, responsive to the receipt of the input weightings, an instruction for ingestion into a large language model configured to construct an output text corpus based on the input text corpus and the instruction; and present, via the user interface, the output text corpus.

The one or more processors may be further configured to present, via the user prompt, an element configured to receive a voice or textual free form entry for the user response.

The input weightings may comprise: a first weighting for a first user associated with a first response; and a second weighting for a second user associated with a second response.

The first weighting may comprise a first weight for a first portion of the input text corpus; and a second weight for a second portion of the input text corpus.

The one or more processors may be further configured to: identify a first revision based on a first of the user responses; identify a second revision based on a second of the user responses; determine a conflict between the first revision and the second revision; and resolve, based on a comparison between the first weighting and the second weighting, the conflict to include, in the text output corpus, one of the first revision or the second revision.

In yet another embodiment, a system for aggregation and visualization may comprise a computing device comprising at least one processor coupled with memory and configured to: receive, from a plurality of users, a corresponding plurality of responses, each response indicative of a user experience; generate, responsive to the receipt of the responses, an instruction for ingestion into a large language model configured to construct a text corpus comprising a summary of the user experiences; and presenting, via a graphical user interface, the text corpus.

The responses may be received via an element of a user interface, the element configured to receive a voice or textual free form entry for the response.

The at least one processor may be configured to: identify, based on the responses, a sentiment associated with the user experiences; predict an action configured to modulate the sentiment; and present, via the user interface, the action.

The presentation of the action may comprise a prediction of a magnitude of a change to the sentiment.

The at least one processor may be configured to present, via the user interface, a plurality of icons corresponding to the plurality of responses, the plurality of icons indicating a sentiment of a corresponding response

### BRIEF DESCRIPTION OF THE DRAWINGS

Various objects, aspects, features, and advantages of the disclosure will become more apparent and better understood by referring to the detailed description taken in conjunction with the accompanying drawings, in which reference characters identify corresponding elements throughout. In the drawings, like reference numbers generally indicate identical, functionally similar, and/or structurally similar elements.

FIG. 1 is an example of a system to aggregate and visualize data, interfacing with a language model, according to some embodiments.

FIG. 2 is flow diagram for a system to aggregate and visualize data, according to some embodiments.

FIG. 3 is flow diagram for a system to aggregate and visualize data, according to some embodiments.

FIG. 4 depicts an example of an instance of a user interface, according to some embodiments.

FIG. 5 depicts an example of an instance of a user interface, according to some embodiments.

FIG. 6 depicts an example of an instance of a user interface, according to some embodiments.

FIG. 7 depicts an example of an instance of a user interface, according to some embodiments.

FIG. 8 depicts an example of an instance of a user interface, according to some embodiments.

FIG. 9 is a block diagram illustrating an architecture for a computer system 900 that can be employed to implement elements of the systems and methods described and illustrated herein.

The details of various embodiments of the methods and systems are set forth in the accompanying drawings and the description below.

### DETAILED DESCRIPTION

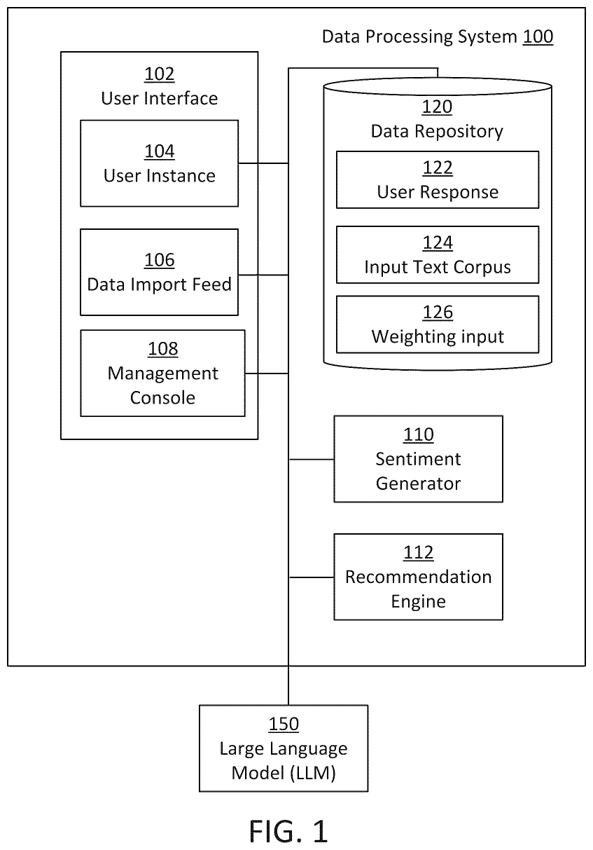

Referring now to FIG. 1, an example of a system to aggregate and visualize data including a data processing system 100 (aggregator) including components interfacing with a machine learning model such as the depicted large language model (LLM) 150, according to various embodiments. The data processing system 100 can aggregate and visualize user feedback for a source such as a document or user experience. The system can include, interface with, or otherwise communicate various components. The data processing system 100 can include or interface with a user interface 102 to receive user responses 122 related to the source. The user interface 102 can include or instantiate any number of user instances 104 to provide a prompt to the user and receive a response therefrom. The user interface 102 can include or instantiate a data import feed 106 to import user responses 122 from a data source. The user interface 102 can include or instantiate a management console 108 to receive weightings for the responses. The data processing system 100 can include or interface with a sentiment generator 110 to generate a sentiment related to responses. The data processing system 100 can include or interface with a recommendation engine 112 to recommend an action to modulate the sentiment.

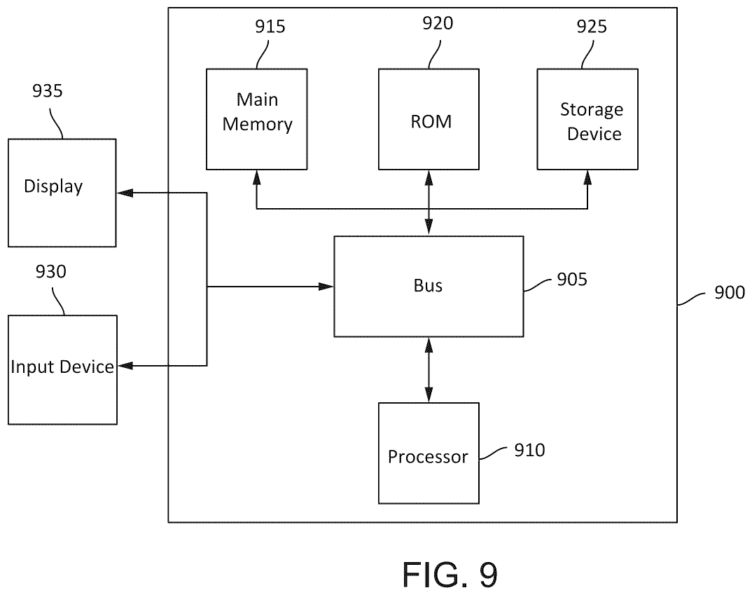

The data processing system 100 can include at least one data repository 120. The user interface 102 and its various components, sentiment generator 110, or recommendation engine 112 can include at least one processing unit or other logic device such as programmable logic array engine, or module configured to communicate with the data repository 120 or database. The user interface 102 and its various components, sentiment generator 110, or recommendation engine 112 can be separate components, a single component, or part of the data processing system 100. The data processing system 100 and its respective models, engines, and other components can include hardware elements, such as one or more processors, logic devices, or circuits, as well as software components. For example, the data processing system 100 can include one or more components or structures of functionality of computing devices depicted in FIG. 9.

The data repository 120 can include one or more local or distributed databases and can include a database management system. The data repository 120 can include computer data storage or memory and can store one or more data structures, such as a data structure corresponding to user responses 122, input text corpora 124, or weightings 126.

A user response 122 can refer to or include responses received via a user instance 104. For example, the user response 122 can include a textual or verbal review provided responsive to a prompt. The prompt can be generated and presented to the user by the data processing system 100 via a user instance 104 of the user interface 102 or another source, as in the case of a review provided to an external data source (e.g., a third-party review site). The review may be associated with any of various user experiences, products, documents, or other items, such as a restaurant, document, seminar, data analytics platform, etc. In some embodiments, the user response 122 may be provided according to a structured form document such as a star rating or a set of structured fields. In some embodiments, the user response 122 can be provided according to an unstructured response, such as a free-form voice or textual entry. In some embodiments, the user response 122 can be provided as a set of revisions or comments regarding an input text corpus 124.

An input text corpus 124 can refer to or include textual content such as textual content of a source document, user, social media post, blog entry, news article, research paper, product description, or any other type of written material. This text corpus can be used for various applications, such as natural language processing, sentiment analysis, or information retrieval. By analyzing the textual content within the corpus, latent information can be decoded. The latent information may be indicative of a sentiment or actions to modulate such a sentiment.

A weighting input(s) 126 can refer to or include an input received from a management console 108 to generate an instruction for provision to a large language model 150. For example, the weighting input 126 can include a weighting for a user response 122 (e.g., an indication that a user response 122 should be highly weighted, lowly weighted, or zero-weighted). The weighting input 126 may correspond to all or a subset of an input text corpus 124 or other input. For example, a weighting input 126 can be provided for a document part (e.g., heading or page) or a subject matter in a document (e.g., grammar or technical content). For example, a weighting input 126 can heavily weight grammatical corrections from a user and lightly weight subject matter clarifications.

The data processing system 100 can include at least one user interface 102 to exchange information between any of various users, data repositories 120 of the data processing system 100, external data sources, and machine learning models such as a non-limiting example of the depicted LLM 150. The user interface 102 can instantiate any number of user instances 104 configured to receive responses from various users. The user interface 102 can include or interface with a data import feed 106 to ingest data from any of various data sources. The user interface 102 can include a management console 108 to receive various weighting inputs 126 and present information related to user responses 122 or outputs of the LLM 150.

Referring again to the at least one user instance 104, the user instance 104 is configured to present a prompt to a user and receive a response therefrom. The user interface can instantiate a user interface for any of various users. For example, the user interface 102 can present a hyperlink, QR code, or other token to aid a user to access the user instance 104 (e.g., via a web page, app, etc.). The user instance 104 can provide a prompt for the user. For example, the prompt can include an element configured to receive a voice or textual free form entry for the response, or one or more structured fields. The prompt can further include instructions or context for the response. The context can include a textual prompt such as a request to provide feedback for a user experience. The context can include a text corpus of a document for review. In some instances, the prompt can include an editable document to revise, or include multiple elements configured to receive separate responses corresponding to subdivisions of the document.

Referring again to the at least one data import feed 106, the user interface can interface, via the data import feed 106, with various data sources. For example, the data import feed 106 can receive stored responses, such as responses received from an off-line instance of the user interface 102 or from a third party (e.g., social media properties, review sites or accumulators, or the like).

Referring again to the at least one management console 108, the management console 108 can receive weighting inputs 126 associated with the user responses 122 received from the various instance of the user interface 102 (also referred to as user instances 104, without limiting effect). For example, a user can input a weighting 126 according to an element of a graphical user interface (GUI) such as a slider, radio button, or drop down menu. In some instances, the management console 108 can receive a zero-weighting, indicating that a user response 122 should be disregarded in generating an output. The inputs weightings 126 can be used to, for example, resolve conflicts between user responses 122 to determine which of conflicting responses should be included in a summary, output document, or other output text corpus.

The management console 108 can present the user responses 122, summaries of the user responses 122, a sentiment of the user responses 122, actions predicted to modulate the user responses (or summaries thereof), or other information. In some embodiments, the management console 108 can is configurable to present a subset of information. For example, the management console 108 can be configured to omit or include an identity of responses or the original content of the user responses 122. Such a configuration may be, according to various embodiments, selectable within a GUI of the management console 108, read from a configuration file of the management console 108, or configurable according to a user privilege (e.g., via token-based authorization).

The data processing system 100 can include or interface with one or more sentiment generators 110 to determine a sentiment associated with a user response 122. The sentiment generator can determine a sentiment based on words, context, sequence, and other aspects of a text corpus of the user response 122. In some embodiments, the sentiment generators 110 can provide the user responses 122 to an LLM 150 along with an instruction to identify a sentiment associated with the user responses 122. For example, the sentiment generator 110 can input each user response 122 into the LLM separately to identify an individual sentiment. The sentiment generator 110 can identify an aggregate sentiment based on the individual sentiments. In some embodiments, the sentiment generator 110 provides, to the LLM 150, an instruction to identify the aggregate sentiment based on the combination of multiple of the user responses 122. The instruction can include, for example, a predefined textual string appended to one or more user responses 122 for ingestion into the LLM 150. The individual or aggregate sentiment can correspond to any of a product, document, user experience, or so on. An icon provided via the management console 108 can indicate a sentiment of a corresponding user response 122.

The data processing system 100 can include or interface with one or more recommendation engines 112 to recommend an action. For example, the recommendation engine 112 can predict an action to modulate the sentiment or the summary. The prediction can be generated according to a predefined input to the LLM, or based on further inputs (e.g., as received via the management console). The recommendation engine 112 can present the action via the management console 108, or another instance of the user interface 102. For example, the action can be configured to reduce an occurrence of words, phrases or grams having a negative connotation in a context as received in the user responses 122. In some embodiments, the presentation of the action can predict a magnitude of a change to the sentiment. For example, the prediction can include a prediction of a magnitude of a change, and the presentation can display the magnitude of the predicted change. In some embodiments, the recommendation engine 112 can predict multiple actions and display a subset of the actions based on a predicted magnitude of the modulation to the sentiment (e.g., according to a ranked-order or comparison to a threshold). The predicted magnitude of the change to the sentiment can include or be based on a frequency of use of terms of sentiment within the input text corpus 124. That is, the LLM 150 or another component of or interfacing with the recommendation engine 112 can predict an action to modulate a sentiment based on a frequency of references to an item (e.g., a magnitude of a change to sentiment based on increased frequency of cleaning can correspond to a number of mentions of cleanliness issues).

The data processing system 100 can include or interface with one or more large language models 150 to generate text corpus outputs based on various inputs (e.g., user responses 122). For example, the inputs can include one or more textual or other inputs (e.g., voice or configuration commands). In some instances, the LLM 150 may be substituted for another machine learning model. For example, another instance of a neural network, such as a sequence-to-sequence model may be employed. The interface with the large language models 150 can be according to a locally operated instance of the LLM 150, or another interface, such as via an application programming interface (API) to couple with an LLM 150 remote from one or more components of the data processing system 100.

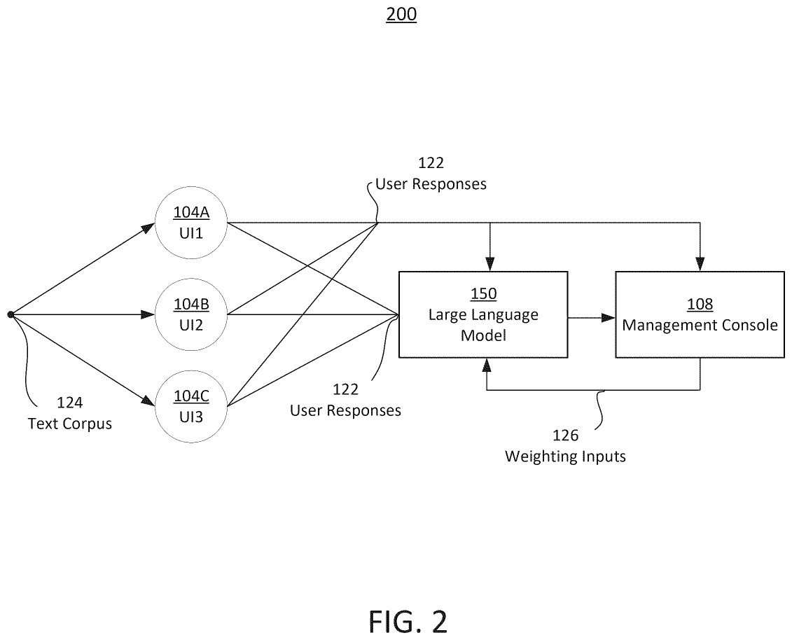

Referring now to FIG. 2, a data flow diagram 200 for aggregation and visualization of data is provided, according to some embodiments. For example, a data processing system 100 can implement the depicted data flow to consolidate various revisions of a same input text corpus 124.

The input text corpus 124 can include a same text corpus presented to each of multiple instances of a user interface 102. For example, as depicted, the input text corpus 124 can be presented via a first user instance 104A, second user instance 104B, and third user instance 104C. Each user instance can correspond to a user. For example, the user instances 104 may be instantiated, by the data processing system 100, based on an email, identity number, phone number or other indicia of identity. For example, the user instances 104 can be instantiated according to a unique identifier for a user to aid in communication therewith (e.g., email, SMS, or identifier for a push notification for a mobile application). The various user instances 104 can display the input text corpus 124 and a prompt for revision. The prompt for revision can include one or more predefined fields, a text editor to manually edit the document, or a voice or textual free form entry. The various user instances 104 can receive, via each of the instances of the user interface 102, a user response 122 to the user prompt. For example, the user response 122 can indicate revisions to the input text corpus 124.

The various user instances 104 can provide the user responses 122 to the language model 150 or a further instance of the user interface (e.g., the management console 108). For example, the management console 108 (or another instance of the user interface 102, such as one of the first user instance 104A, second user instance 104B, or third user instance 104C) can present the responses. In some embodiments, the data processing system 100 provides the user responses 122, along with the input text corpus 124, to the LLM 150. The data processing system 100 may further provide instructions to the LLM 150. For example, the instructions can cause the LLM 150 to generate an updated text corpus (which may be referred to as an output text corpus) or a summary of one or more of the user responses 122. In some embodiments, the data processing system 100 is configured to receive, from the LLM 150, a summary of each of the various user responses 122 and convey the summaries of the user responses 122 to a management console or other instance of the user interface 102. The data processing system 100 can present, via the management console 108 or other instance of the user interface 102, the user responses 122 or summaries thereof. The data processing system 100 can also present the output text corpus to at least the management console 108.

The data processing system 100 can receive, from the management console 108, input weightings 126 for the user responses 122. For example, the management console 108 can receive a relative or absolute input weighting 126 for each of the various user responses 122 (or summaries) such that an updated output text corpus can be generated by the LLM 150. That is, the inputs to the management console 108 can iteratively provide updates to the output text corpus. The input weighting 126 can be based on a selection of a user associated with a user instance 104 for the entirety of the input text corpus 124 or a portion thereof (e.g., subject matter or document subdivision). For example, the management console 108 can generate an instruction for ingestion by the large language model 150 (e.g., comprising a series of predefined text strings corresponding to the selected input weightings 126), to cause the LLM 150 to construct an output text corpus based on the input text corpus 124. The user interface 102 can output the output text corpus via the management console 108 or another instance of the user interface, such as the first user instance 104A, second user instance 104B, or third user instance 104C.

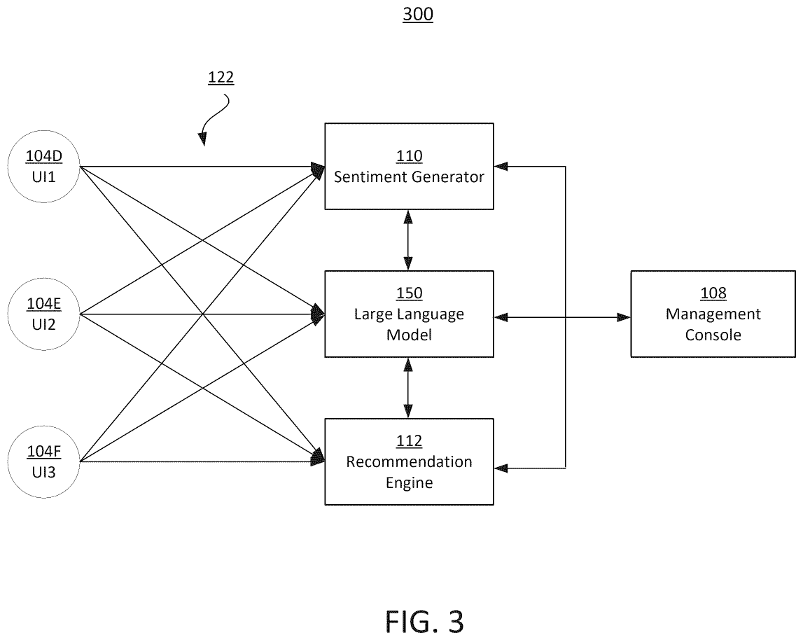

Referring now to FIG. 3, a data flow diagram 300 for aggregation and visualization of data is provided, according to some embodiments. For example, a data processing system 100 can implement the depicted data flow to aggregate various input text corpora 124, such as a set of user reviews generated in response to a study or as received from another data source (e.g., via the data import feed 106, such as for a receipt of input text corpora 124 scraped from third party sources).

The data processing system 100 can receive, from each of various user interfaces, (e.g., a fourth user instance 104D, fifth user instance 104E, and sixth user instance 104F, which may be or be separate from the first user instance 104A, second user instance 104B, and third user instance 104C). The various user instances 104 can present, for a user corresponding thereto, a prompt for a user response 122 related to a user experience. For example, the prompts can be generated responsive to a study request implemented via a management console 108. The various user instances 104 can receive user responses 122 in response to the prompts.

The user instances 104 can provide, to the LLM 150 (e.g., directly or via a management console 108, sentiment generator 110, or recommendation engine 112), the user responses 122. The data processing system 100 (e.g., the user instances 104, management console 108 or sentiment generator 110) can generate an instruction for ingestion into the LLM 150. The instruction can be configured to cause the LLM 150 to construct an output text corpus including a summary of the user experiences, a sentiment associated with the user experiences, or an action configured to modulate the sentiment. The user interface 102 can present the output text corpus via the user interface 102 (e.g., the management console 108). The output can include further controls to modulate the output or predictions of actions to so modulate a sentiment associated with the user responses 122.

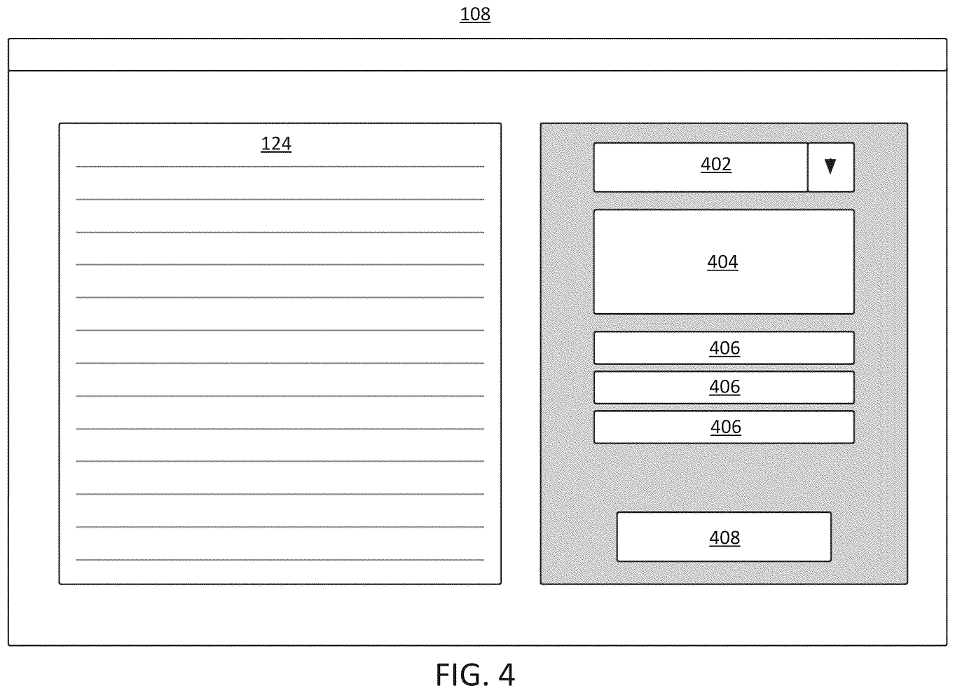

Referring now to FIG. 4, an example instance of a user interface 102 is provided, according to some embodiments. For example, the depicted management console 108 can be a management console 108 associated with the data flow of FIG. 2.

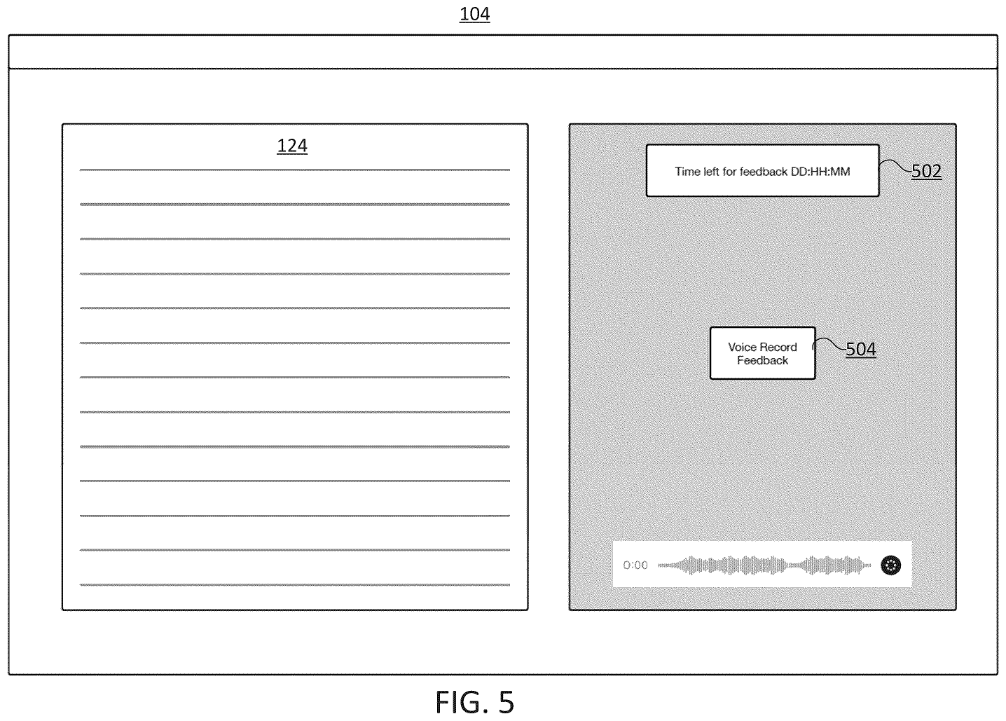

The management console 108 can include a depiction (e.g., summary or entirety) of an input text corpus 124. The input text corpus 124 can be provided (e.g., uploaded, selected, or linked) via the management console 108. The management console 108 can include a first element 402 configured to receive a target date for feedback, such as via a dropdown selector or predefined offset from a selection. The management console 108 can include a second element 404 configured to provide notes related to the input text corpus 124. The data processing system 100 can provide the notes to various reviews to aid in a review, or to an LLM 150 to aid in aggregating any received user responses 122. The management console 108 can include a third element 406 to receive an identity of a various users associated with user instances 104 of the user interface 102. For example, the identity can be received as contact information (e.g., phone number, email, advertiser ID) or another unique identifier which corresponds to stored contact information for a user. The depicted instance of the management console 108 includes three instances of the third element 406, corresponding to three users. Various other illustrative examples may include additional or fewer instances of the third element 406. The management console 108 can include a fourth element 408 configured to initiate the instantiation of various instances of the user instances 104 (e.g., the first instance 104A, second instance 104B, and third instance 104C of FIG. 2). Upon an actuation of the fourth element 408, the data processing system 100 can cause an instantiation of the user interface 102 instance of FIG. 5 (e.g., begin a study).

Referring now to FIG. 5, an example instance of a user interface 102 is provided, according to some embodiments. For example, the depiction can provide an instance of a user instance 104. For example, the user instance 104 can be a user instance 104 associated with the data flow of FIG. 2.

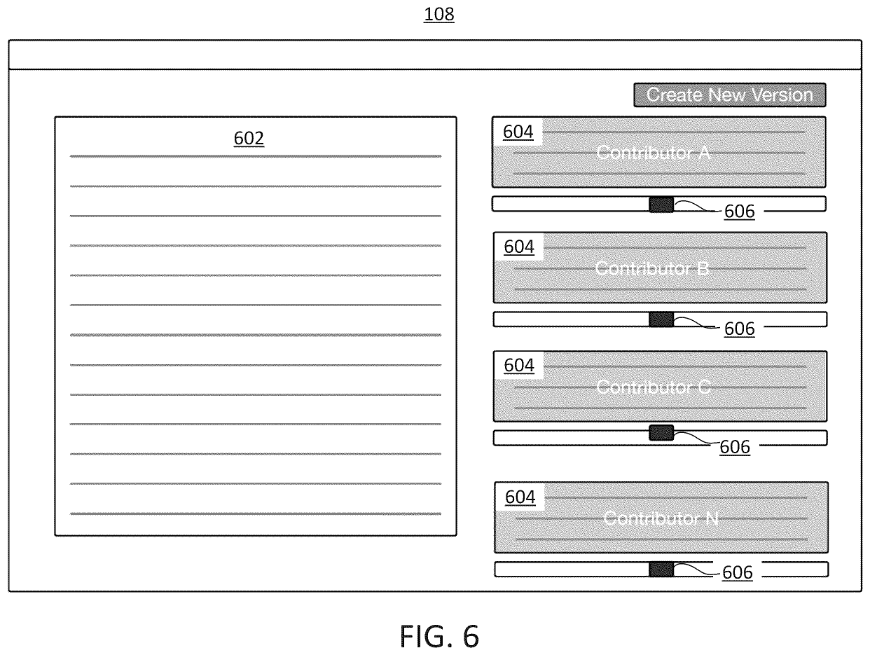

The user instance 104 can be associated with (e.g., depict) a deadline 502, corresponding to the first element 402 of FIG. 4, upon an expiration of which, a user response 122 corresponding to a user associated with the user instance 104 may be omitted. The user instance 104 can include a control element 504 to receive input (e.g., voice input). In some embodiments, the user instance 104 can receive further inputs to the input text corpus 124, such as via a text editor for the input text corpus 124. Upon an expiration of the deadline, a provision of feedback by the various users, or another trigger, the various user instances 104 can convey the user responses 122 to another component of the data processing system 100 (e.g., the management console 108 or LLM 150). Upon a receipt of the user responses 122, the data processing system 100 can generate a view in the management console 108 as depicted henceforth at FIG. 6.

Referring now to FIG. 6, an example instance of a user interface 102 is provided, according to some embodiments. For example, the depiction can provide an instance of a management console 108 associated with the data flow of FIG. 2.

The management console 108 can depict an output text corpus 602 (as generated by the LLM 150) based on the user responses 122. The output text corpus 602 may be dynamic, such as based on input weightings 126 provided for the various user response 122. The management console 108 can depict an indication 604 of the various user responses 122 (e.g., a summary thereof) and a control element 606 to modulate an effect of the various user responses 122 (e.g., by generating instructions for ingestion by the LLM 150). Accordingly, according to the actuation of the control element 606 (e.g., movement of a slider), the output text corpus 602 can be modulated.

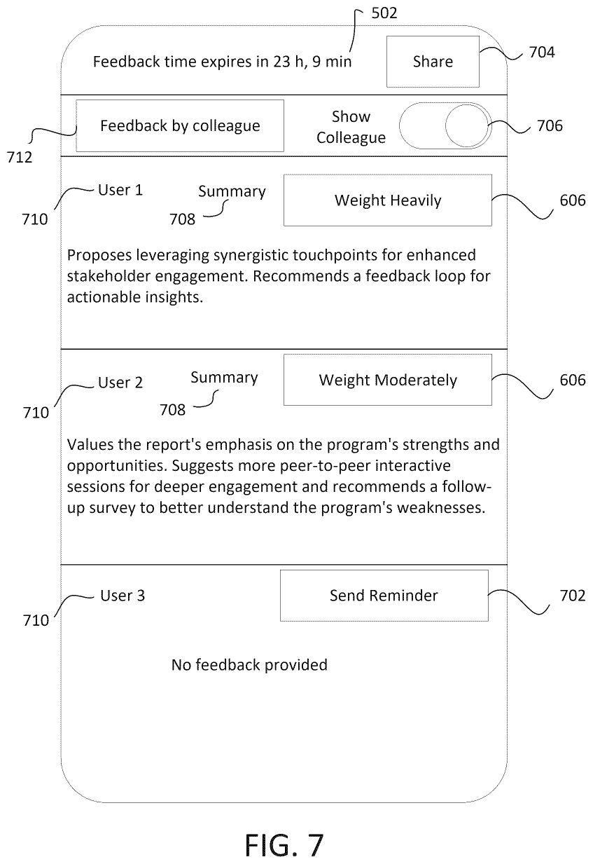

Referring now to FIG. 7, an example instance of a user interface 102 is provided, according to some embodiments. For example, the example depiction can provide an instance of a management console 108 associated with the data flow of FIG. 2.

As depicted in FIG. 5 and FIG. 6 above, the management console 108 can include an indication of a deadline 502 and a control element 606 to provide a weighting input 126. The depicted control element 606, differing from the control element 606 of FIG. 6, can include a drop down box, free form entry for text or speech, or another type of control element 606. Further depicted is an example of a routing instruction, which can include a reminder 702, cancelation, deadline adjustment, or other control to modulate a display of a user instance 104. In some embodiments, the routing instruction can include an indication to instantiate additional user instances 104 of the user interface or provide access to the view of the management console 108 (e.g., a “share” control 704).

The management console 108 can include elements to adapt the provided view. For example, an anonymization control 706 can cause colleagues to be shown or omitted. Even where speech or written patterns may be recognizable, the management console 108 can provide a summary control 708 to provide a summary of feedback rather than a literal response, which may further anonymize data and ease review. Thus, an identity of a user 710 (or an anonymized token) can be provided in the management console 108 to distinguish between users associated with the various user responses 122. In some embodiments, the management console 108 can provide additional views, such as a selection between feedback by colleague 712, feedback by section, feedback by subject matter, aggregated feedback, or so forth.

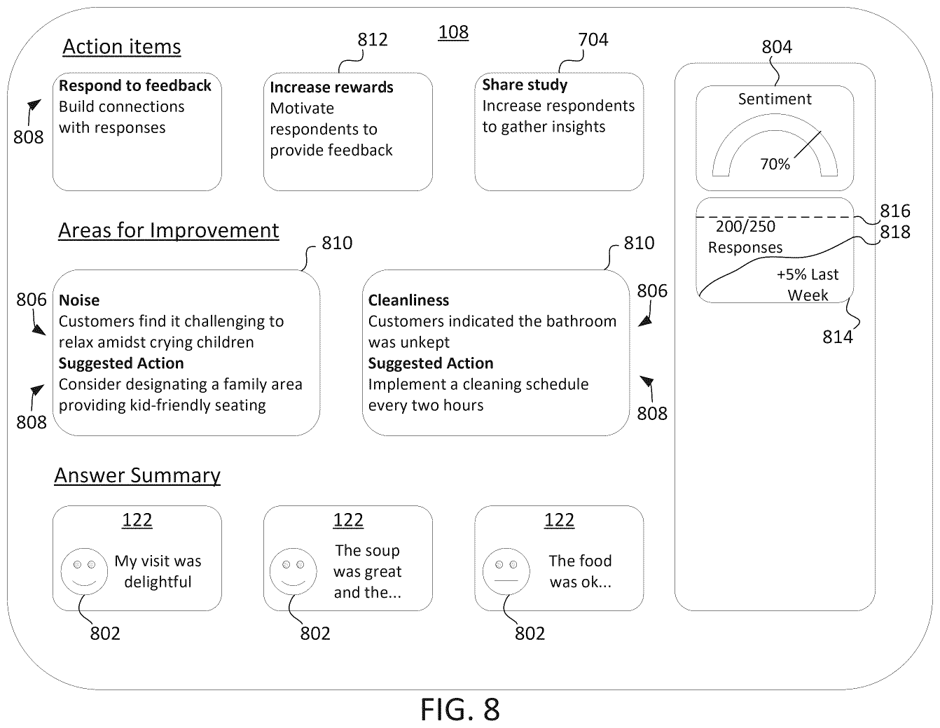

Referring now to FIG. 8, an example instance of a user interface 102 is provided, according to some embodiments. For example, the depiction can provide an instance of a management console 108 associated with the data flow of FIG. 3.

The management console 108 can include one or more user responses 122 or indicia thereof. For example, the management console 108 can include a summary of all or selected user responses 122 or an icon 802 indicating a sentiment of a corresponding to the user response 122. The management console 108 can include various control elements, such as further instances of the share control 704, or further control elements, such as a control element 812 to generate further user responses 122. The management console 108 can provide an indication of the tracking of the user responses, such as according to a GUI element 814 including a target response 816 and a realized response to date 818.

The management console 108 can provide indicia of sentiment. For example, an aggregate sentiment score 804 can be provided, or textual summaries of experiences corresponding to the sentiment can be provided. The textual summaries (e.g., areas for improvement, areas for maintenance) may be provided according via the sentiment generator 110 (e.g., according to an instruction generated by the sentiment generator 110 and ingested into the LLM 150). For example, the user interface can indicate a sentiment modulator summary 806 to indicate a driver of sentiment or an action 808 configured to modulate the sentiment (e.g., as a paired set 810).

FIG. 9 is a block diagram illustrating an architecture for a computer system 900 that can be employed to implement elements of the systems and methods described and illustrated herein. For example, the computer system can be implanted in one or more desktop or laptop computers or computing devices configured to provide an instance of a user interface 102 or exchange data between the various components of the data processing system. The computer system or computing device 900 can include or be used to implement a controller or its components, and components thereof. The computing system 900 includes at least one bus 905 or other communication component for communicating information and at least one processor 910 or processing circuit coupled to the bus 905 for processing information. The computing system 900 can also include one or more processors 910 or processing circuits coupled to the bus for processing information. The computing system 900 also includes at least one main memory 915, such as a random-access memory (RAM) or other dynamic storage device, coupled to the bus 905 for storing information, and instructions to be executed by the processor 910. The main memory 915 can be used for storing information during execution of instructions by the processor 910. The computing system 900 may further include at least one read only memory (ROM) 920 or other static storage device coupled to the bus 905 for storing static information and instructions for the processor 910. A storage device 925, such as a solid-state device, magnetic disk or optical disk, can be coupled to the bus 905 to persistently store information and instructions (e.g., for the data repository 120).

The computing system 900 may be coupled via the bus 905 to a display 935, such as a liquid crystal display, or active-matrix display. An input device 930, such as a keyboard or mouse may be coupled to the bus 905 for communicating information and commands to the processor 910. The input device 930 can include a touch screen display 935.

The processes, systems and methods described herein can be implemented by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein. One or more processors in a multi-processing arrangement may also be employed to execute the instructions contained in main memory 915. Hard-wired circuitry can be used in place of, or in combination with, software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware may be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
presenting a plurality of instances of a user interface to a corresponding plurality of users, each instance comprising a user prompt;
receiving, via each of the plurality of instances of the user interface, a user response to the user prompt;
generating, responsive to the receipt of the user responses, an instruction for ingestion into a large language model configured to construct an output text corpus; and
presenting, via the user interface, the output text corpus.

2. The computer-implemented method of claim 1, wherein the user prompt comprises:
a voice or textual free form entry.

3. The computer-implemented method of claim 1, wherein:
the plurality of instances of the user interface are configured to present an input text corpus, the user responses indicative of changes to the input text corpus; and
the instructions comprise instructions to modify the input text corpus based on the user responses, to generate the output text corpus.

4. The computer-implemented method of claim 1, further comprising:
presenting, based on the user responses, a second user prompt providing an indication of the responses; and
receiving, responsive to the second user prompt, a user selection input, wherein the instruction is generated based on the user selection input, the user selection input comprising:
an input weighting for at least one of the user responses.

5. The computer-implemented method of claim 4, wherein the input weighting comprises a first weight for a first portion of the text corpus and a second portion for a second portion of the text corpus.

6. The computer-implemented method of claim 5, wherein the input weighting comprises a zero-weight for at least one user responses.

7. The computer-implemented method of claim 1, wherein:
each of the user responses comprise a description of a user experience; and
the output text corpus comprises a summary of the user experiences.

8. The computer-implemented method of claim 7, further comprising:
identifying, based on the user responses, a sentiment associated with the user experiences;
predicting an action configured to modulate the sentiment; and
presenting, via the user interface, the action.

9. The computer-implemented method of claim 8, wherein:
the presentation of the action comprises a presentation of a predicted magnitude of a change to the sentiment.

10. The computer-implemented method of claim 7, further comprising:
presenting, via the user interface, a plurality of icons corresponding to the plurality of user responses, the plurality of icons indicating a sentiment of a corresponding user responses.

11. A system for revision consolidation, the system comprising one or more processors coupled with memory and configured to:
present, via a plurality of first instances of a user interface associated with a corresponding plurality of users, an input text corpus and a user prompt to indicate a request for revisions to the input text corpus;
receive, via each of the plurality of first instances of the user interface, a user response to the user prompt, the user response comprising indicia of the revisions;
present, via a second instance of the user interface, an indication of the user responses;
receive, from the second instance of the user interface, input weightings for the user responses;
generate, responsive to the receipt of the input weightings, an instruction for ingestion into a large language model configured to construct an output text corpus based on the input text corpus and the instruction; and
present, via the user interface, the output text corpus.

12. The system of claim 11, wherein the one or more processors are further configured to:
present, via the user prompt, an element configured to receive a voice or textual free form entry for the user response.

13. The system of claim 11, wherein the input weightings comprise:
a first weighting for a first user associated with a first response; and
a second weighting for a second user associated with a second response.

14. The system of claim 13, wherein the first weighting comprises:
a first weight for a first portion of the input text corpus; and
a second weight for a second portion of the input text corpus.

15. The system of claim 13, wherein the one or more processors are further configured to:
identify a first revision based on a first of the user responses;
identify a second revision based on a second of the user responses;
determine a conflict between the first revision and the second revision; and
resolve, based on a comparison between the first weighting and the second weighting, the conflict to include, in the text output corpus, one of the first revision or the second revision.

16. A system for aggregation and visualization, the system comprising a computing device comprising at least one processor coupled with memory and configured to:
receive, from a plurality of users, a corresponding plurality of responses, each response indicative of a user experience;
generate, responsive to the receipt of the responses, an instruction for ingestion into a large language model configured to construct a text corpus comprising a summary of the user experiences; and
presenting, via a graphical user interface, the text corpus.

17. The system of claim 16, wherein the responses are received via an element of a user interface, the element configured to receive a voice or textual free form entry for the response.

18. The system of claim 16, wherein the at least one processor is configured to:
identify, based on the responses, a sentiment associated with the user experiences;
predict an action configured to modulate the sentiment; and
present, via the user interface, the action.

19. The system of claim 18, wherein the presentation of the action comprises a prediction of a magnitude of a change to the sentiment.

20. The system of claim 17, wherein the at least one processor is configured to:
present, via the user interface, a plurality of icons corresponding to the plurality of responses, the plurality of icons indicating a sentiment of a corresponding response.
